(19) United States
(12) Patent Application Publication
(10) Pub. No.: US 2025/0199852 A1
(43) Pub. Date: Jun. 19, 2025

(54) MATRIX SCHEDULER AND METHOD FOR MATRIX SCHEDULING CONCENTRATING DEPENDENCY INFORMATION IN COLUMN

(71) Applicant: Fujitsu Limited, Kawasaki-shi (JP)

(72) Inventors: Sota Sakashita, Kawasaki (JP); Ryohei Okazaki, Kawasaki (JP); Gen Oshiyama, Kawasaki (JP); Chunye You, Kawasaki (JP)

(73) Assignee: Fujitsu Limited, Kawasaki-shi (JP)

(21) Appl. No.: 18/946,243

(22) Filed: Nov. 13, 2024

(30) Foreign Application Priority Data
Dec. 13, 2023 (JP) 2023-210272

(51) Int. Cl. G06F 9/48; G06F 9/38

(52) U.S. Cl. CPC G06F 9/4881; G06F 9/3838

(57) ABSTRACT

A matrix scheduler that concentrates dependency information in a column includes: a memory; and a processor being coupled to the memory and including a matrix table containing an at most N×M cells and 1×M cells, where N and M are independently of each other natural numbers more than one, the 1×M cells storing a grant signal, the processor being configured to store a dep signal into each of the N×M cells, the dep signal indicating the cell has dependency of a producer of an entry of the cell, when an instruction is issued from the matrix scheduler, set a bit of the grant signal corresponding to an issued scheduler entry to 1, and when products of the dep signals of cells in one row of the matrix table and an inverted signal of the grant signal are all zero, execute the instruction.

### CROSS-REFERENCE TO RELATED APPLICATION

This application is based upon and claims the benefit of priority of the prior Japanese Patent application No. 2023-210272, filed on Dec. 13, 2023, the entire contents of which are incorporated herein by reference.

### FIELD

The embodiment discussed herein relates to a matrix scheduler and a method for matrix scheduling concentrating dependency information in a column.

### BACKGROUND

A scheme called instruction scheduling is one of optimization method that arranges an instruction string in a core part of a processor such that the instruction string is executed as quickly as possible. In recent years, the number of scheduler entries has been increasing in order to deal with the high-performance requirements of a processor.

For example, related arts are disclosed in Japanese Laid-open Patent Publication No. HEI 6-28324.

### SUMMARY

According to an aspect, a matrix scheduler that concentrates dependency information in a column includes: a memory; and a processor being coupled to the memory and including a matrix table containing an at most N×M cells and 1×M cells, where N and M are independently of each other natural numbers more than one, the 1×M cells storing a grant signal, the processor being configured to store a dep signal into each of the N×M cells, the dep signal indicating the cell has dependency of a producer of an entry of the cell, when an instruction is issued from the matrix scheduler, set a bit of the grant signal corresponding to an issued scheduler entry to 1, and when products of the dep signals of cells in one row of the matrix table and an inverted signal of the grant signal are all zero, execute the instruction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating an example of a configuration of a processor core;

FIG. 2 is a diagram illustrating an example of an instruction string of a related example;

FIG. 3 is a diagram illustrating a first state of a dependency matrix table of the related example;

FIG. 4 is a diagram illustrating a second state of the dependency matrix table of the related example;

FIG. 5 is a circuit diagram illustrating a dep signal and a pend signal

of the related example;

FIG. 6 is a diagram illustrating a first state of a dependency matrix table of an embodiment;

FIG. 7 is a diagram illustrating a second state of a dependency matrix table of the embodiment;

FIG. 8A is a circuit diagram illustrating a dep signal of the embodiment and FIG. 8B is a circuit diagram illustrating a grant signal of the embodiment;

FIG. 9 is a diagram illustrating an example of instruction strings of the embodiment;

FIG. 10 is a diagram illustrating a first state of a dependency matrix table of a first modification;

FIG. 11 is a diagram illustrating a second state of the dependency matrix table of the first modification;

FIG. 12 is a diagram illustrating a third state of the dependency

matrix table of the first modification;

FIG. 13 is a diagram illustrating a fourth state of the dependency matrix table of the first modification;

FIG. 14 is a diagram illustrating a dependency matrix table of a second modification;

FIG. 15 is a circuit diagram of each cell in the encoding scheme in the

second modification; and

FIG. 16 is a circuit diagram illustrating a dep_val signal and a dep_id signal of the second embodiment.

### DESCRIPTION OF EMBODIMENT(S)

The miniaturization in the field of the semiconductor technology has increased a ratio of wiring delay among circuit delay. Increasing in a circuit volume leads to not only gate delay due to the number of transistor stages but also worsening of wiring delay due to an increase in circuit area, and therefore is a barrier to an increase of the number of entries of a scheduler to hinder enhancement in performance.

### (A) Embodiment

Hereinafter, an embodiment will now be described with reference to the accompanying drawings. However, the following embodiment is merely illustrative and is not intended to exclude the application of various modifications and techniques not explicitly described in the embodiment. Namely, the present embodiment can be variously modified and implemented without departing from the scope thereof. Further, each of the drawings can include additional elements not illustrated therein to the elements illustrated in the drawing.

### (A-1) Related Example

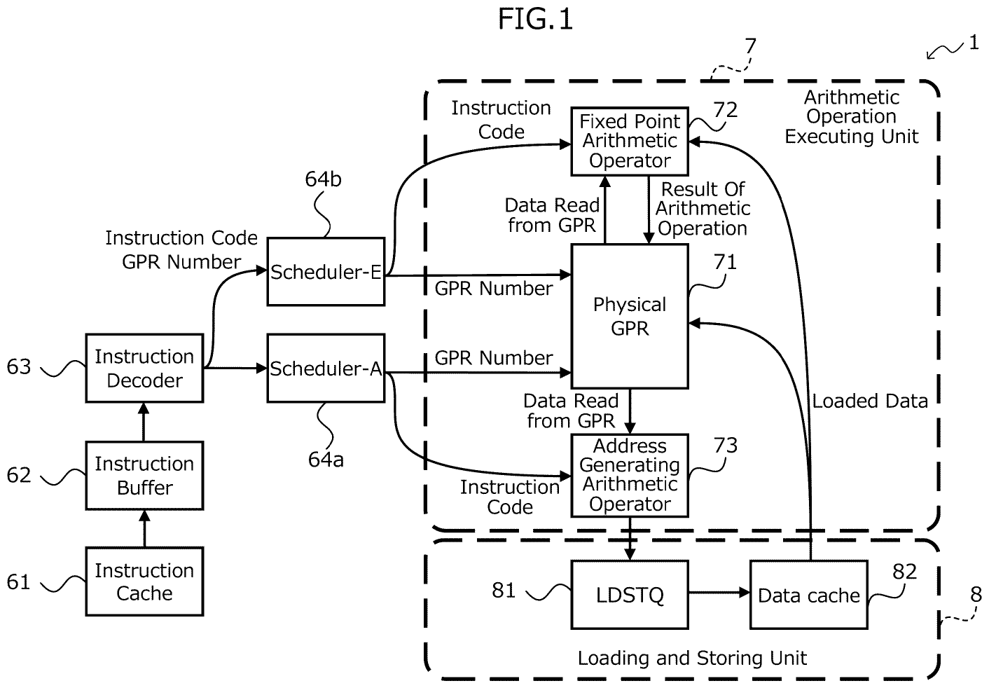

FIG. 1 is a block diagram schematically illustrating an example of a configuration of a processor core 1.

The processor core 1 includes an instruction cache 61, an instruction buffer 62, an instruction decoder 63, a scheduler-A 64a, a scheduler-E 64b, an arithmetic operation executing unit 7, and a loading and storing unit 8.

The arithmetic operation executing unit 7 includes a physical GPR (General Purpose Register) 71, a fixed point arithmetic operator 72, and an address generating arithmetic operator 73.

The loading and storing unit 8 includes an LDSTQ (Load Store Queue) 81 and a data cache 82.

Instructions that instruct operations of the processor core 1 are stored in the instruction cache 61. Instruction codes read from the instruction cache 61 are stored in the instruction buffer 62 and sequentially sent to the instruction decoder 63.

The instruction decoder 63 carries out instruction interpretation and stores information such as an instruction code into a scheduler.

The scheduler accumulates instructions and speculatively issues the instructions to an arithmetic operator or a cache memory in order of coming to be ready.

In FIG. 1, a scheduler-E 64b that stores arithmetic operation instructions and a scheduler-A 64a that stores memory access instructions such as loading and storing instructions are provided.

The scheduler-E 64b, which stores arithmetic operation instructions, has an output connected to the physical GPR 71 and the fixed point arithmetic operator 72 of the arithmetic operation executing unit 7. The scheduler-A 64a, which accumulates memory access instructions, has an output connected to the physical GPR 71 and the address generating arithmetic operator 73 of the arithmetic operation executing unit 7 and further connected to the loading and storing unit 8 beyond the address generating arithmetic operator 73.

A memory access instruction output from the scheduler-A 64a refers to the physical GPR 71 to calculate the access address to calculate the access address, and the address generating arithmetic operator 73 carries out a process such as an addition using read data.

The address obtained in the above manner is then sent to the loading and storing unit 8 and accumulated in a queue called the LDSTQ 81, and are used to access a data cache sequentially. If the instruction is a loading instruction, data is output from the cache. If the instruction is a fixed-point loading, the data of the instruction is written into the physical GPR 71.

An arithmetic operation instruction output from scheduler-E 64b refers to the physical GPR 71, executes a fixed point arithmetic operation using read data, and writes the result into the physical GPR 71. Although being omitted in FIG. 1, the scheduler-E 64b can also accumulate floating point arithmetic instructions, and in this event, a floating point arithmetic instructions issued from the scheduler-E 64b executes a floating-point arithmetic operation by referring to the physical GPR 71 in the arithmetic operation executing unit 7.

A scheduler having a function of controlling the order of issuing instructions having dependency and carrying out coordination control for issuing issuable instructions in an out-of-order manner.

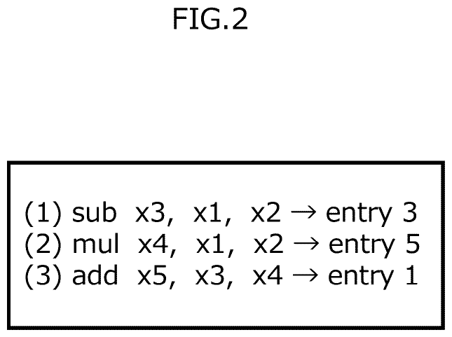

FIG. 2 is a diagram illustrating an example of an instruction string of the related example.

For example, in the instruction string of FIG. 2, the instruction (1)sub carries out subtraction by referring to x1 and x2 of a fixed point register and updates x3 with the result of the subtraction. The instruction of (2)mul multiplies x1 and x2 and updates x4. The instruction (3)add adds the x3 and the x4 and updates the x5.

Since the x3 and x4 that the instruction (3)add uses are the result of the instruction (1)sub and the result of the instruction (2)mul, respectively, the instruction (1)sub and the instruction (2)mul have dependency with respect to the instruction (3)add.

A scheduler can issue instructions out of the original instruction order.

However, if these instructions have dependency as the above, issuing of the instruction (3)add needs to wait until the execution of the instructions of (1)sub and (2)mul.

Among such instructions having dependency, an instruction, such as (1)sub and (2)mul, that updates the register is called a producer, and an instruction that uses a register updated by a producer is called a consumer.

The scheduler manages the relationship between a producer and a consumer with a dependency matrix table that can deal with cancellation after an instruction is issued.

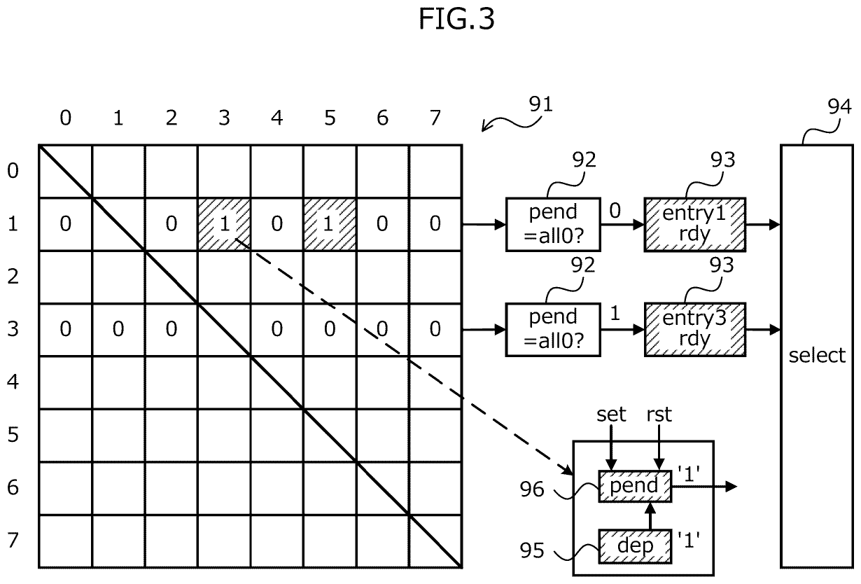

FIG. 3 is a diagram illustrating a first state of the dependency matrix table of the related example.

FIG. 1 illustrates a configuration using two schedulers, but for simplicity of explanation, but the following description assumes a single scheduler consists of eight entries for simplification of the description. If the instruction (1)sub, the instruction (2)mul, and the instruction (3)add are respectively stored in the entry 3, the entry 5, and the entry 1 in the scheduler in executing the instruction string of FIG. 2, the dependency matrix table comes into a state illustrated in FIG. 3.

In the example illustrated in FIG. 3, a row of a matrix table 91 corresponds to an entry number of a consumer and a column corresponds to a entry number of a producer.

Each entry of the scheduler has seven cells in the row direction, and the position of each cell indicates a corresponding entry number of the producer.

Each cell in the matrix retains two-bit data of pend 96 and dep 95 indicating dependency. The dep signal indicates the presence of dependency with a producer of the corresponding entry, and the pend indicates the state of execution of the producer. The pend set to 1 indicates that the producer has not yet been executed. As illustrated at the reference sign 92, the pend set to 0 indicates that dependency is absent or the dependency was present but the producer has been already issued and executed an arithmetic operation.

For example, in FIG. 3, the instruction (3)add stored in the entry 1 depends on both the entry 3 and the entry 5 respectively storing the instruction (1)sub and the instruction (2)mul, and therefore the bit 3 and bit 5 indicate 1 and the remaining bit indicate 0. A rdy signal, which indicates that an instruction can be issued from the scheduler (see the reference sign 93), does not become 1 unless every bit that the entry has becomes 0. For the above, since the entry 1 has rdy=0 in the state of FIG. 3, an instruction is not issued from a select 94 of the scheduler.

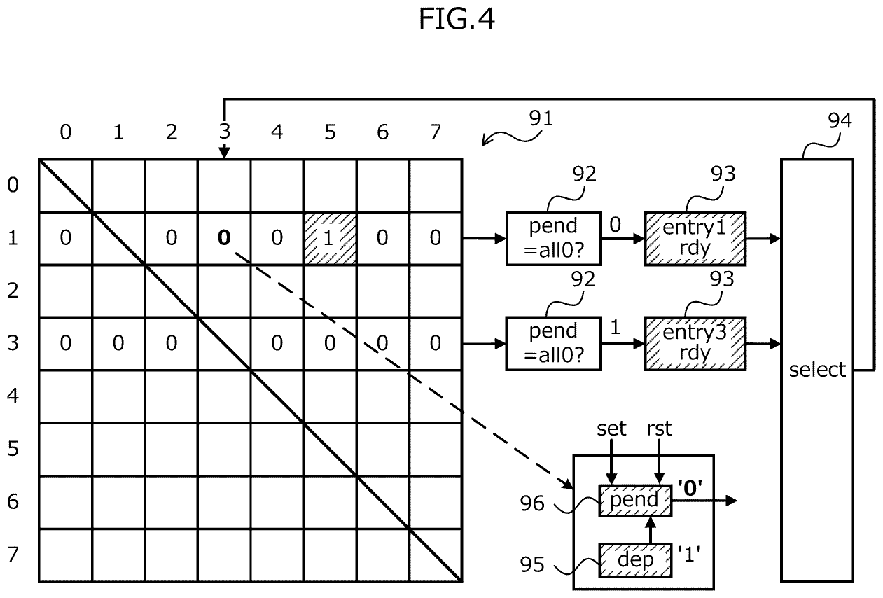

FIG. 4 is a diagram illustrating a second state of the dependency

matrix table of the related example.

When the instruction (1)sub is issued from the scheduler, since (1)sub is stored in the entry 3 as illustrated in FIG. 4, the signal is asserted in the column direction of the matrix table 91 and all the pend set to 1 are dropped to 0.

After that, when an instruction is issued from the entry 5, all the pends (see the reference sign 92) in the row direction of the entry 1 become 0 and the rdy of the entry 1 becomes 1 (see the reference sign 93), so that the select 94 can issue an instruction.

In this way, the scheduler grasps the dependency among instructions and controls issuance according to the order by updating a state issuance of the producers.

An instruction issued from the scheduler may be canceled for some reason and return to the scheduler. In this case, a cancelling signal is asserted in the column direction, and the signal is set back to 1 to return to the state of FIG. 1. In this case, only pend signals which originally have the dependency can be returned to 1, only the pends in cells having dep signals set to 1 are changed to 1.

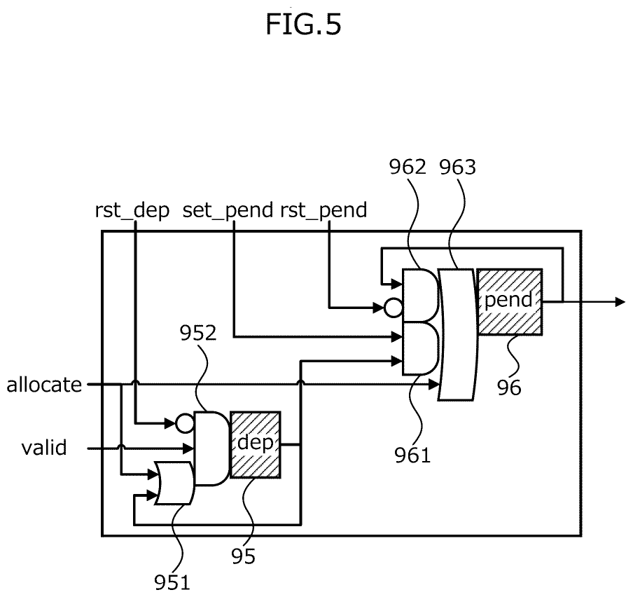

FIG. 5 is a circuit diagram illustrating a dep signal 95 and a pend signal 96 of the related example.

The dep signal 95 is set to 1 when an instruction is registered (allocated) in the scheduler. For this reason, an output looped back from a Flip Flop and a logical disjunction (OR) by an OR gate 951 are set in the Flip Flop to hold the value.

A valid is a valid of the scheduler entry and is a signal of the consumer. An instruction is issued from the scheduler and clear (in other words, releases) the valid of its own entry when the process is finished. Since the dep signal 95 needs to be 0 when another next instruction is registered, the dep signal is set by an AND gate 952 implementing a logical conjunction (AND) of the valid and the dep signal 95 is also reset in synchronization with valid=0.

The dep signal 95 is also reset by a rst_dep signal. The rst_dep signal is a signal notified when a producer having dependency is released from the scheduler, and is signal notified in the column direction of the table.

Since an entry of a scheduler of which instruction has been released is subsequently registered with another instruction, the entry is configured to drop the dep signal in order to prevent a pend from being set/reset by the another instruction. For the above, the dep signal 95 is subjected to calculation of a logical conjunction with a setting condition of the pend signal 96 by an AND gate 961, and the pend becomes 0 when dep=0.

A set_pend and a rst_pend connected to the pend signal 96 are signals the same as the set and the rest illustrated in FIGS. 3 and 4.

The rst_pend signal is a signal that is set to 1 by being subjected to calculation of a logical conjunction by the AND gate 962 when an instruction is issued from the scheduler.

Outputs from the AND gates 961 and 962 and the allocate are subjected to calculating a logical disjunction (OR) by an OR gate 963 to give a pend signal 96.

An instruction issued by the scheduler may fail in execution due to a cache miss, for example. In this case, the failed instruction is returned to the scheduler and reissued. Returning to the scheduler means that the instruction is returned to a state where the instruction is not issued yet, so that the pend signal of the consumer needs to be set again. Therefore, when the instruction returns to the scheduler, a set_pend signal is notified in the column direction.

Since a signal indicating that the instruction has been issued is notified only in one cycle, the conventional scheme is called the pulse scheme here. In the pulse scheme, unless a consumer is not present in a scheduler at the time the producer issues an instruction, a bit of dependency table is not able to be set to 0.

In preparation for a case where the timing at which a consumer is registered in the scheduler is later than notification of issuance by a producer, the pulse scheme needs to include a management table that grapes a state of issuance of the producer and refer to the management table immediately before the consumer is registered in the scheduler, so that the increase in circuit volume and the complexity of a circuit are concerned.

### (A-2) Example of Configuration

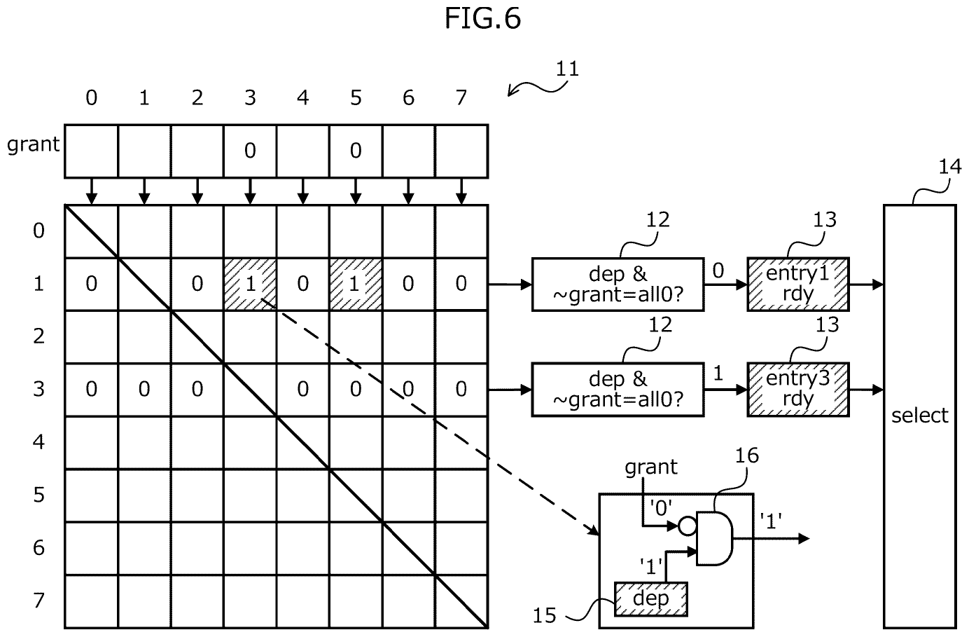

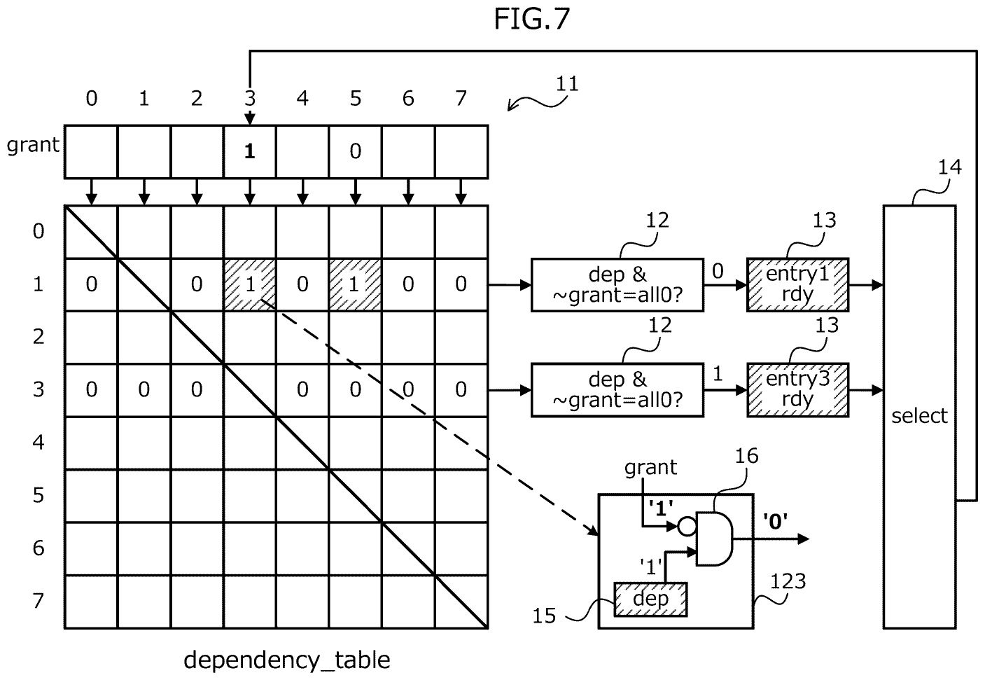

FIG. 6 is a diagram illustrating a first state of a dependency matrix table of an embodiment. FIG. 7 is a diagram illustrating a second state of the dependency matrix table of the embodiment.

The present embodiment proposed a level-type dependency matrix table that minimizes an increase in circuit by commonly using the pend signals and transforming a resource which has been held in a matrix into a resource held in a column.

The dependency matrix table of FIG. 6 additionally have a grant signal on the top of the matrix table 11 as compared with the dependency matrix table of the related example illustrated in FIG. 3.

The grant signal is a signal that is held and updated by a FF (Flip Flop) consisting of the number bits corresponding to the number of entries in scheduler (i.e., the number of columns of the dependency matrix table) or a latch. Since the addition of the grant signal can eliminate the pend signal of each cell, the number of bits in a storing device such as a FF of each cell is halved.

Although the values in the matrix table 91 of FIGS. 3 and 4 are the values of a pend signal, the values in the matrix table 11 of FIG. 6 are the values of a dep signal.

The grant signal is a signal having the same number of bits as the number of entries of the scheduler, and a signal indicating an issuance state of producers. Since a grant signal indicates a state of issuance of producers, the value 1 is set in a bit of the grant signal corresponding to an issued scheduler entry when an instruction is issued from a selector 14 of a scheduler as illustrated in FIG. 7. If the instruction is to be cancelled, it is sufficient that the corresponding grant signal is set to 0 again.

A grant signal 17 is notified to all the entries of the scheduler.

Each cell of the matrix table 11 has only a dep signal indicating which entry in a scheduler is depended. When all the bits in a row direction of dep & ˜grant represented by the reference sign 12 becomes 0 in the row direction, rdy=1 represented by the reference sign 13 can be set to 1.

The presence of the grant signal eliminates the need for the pend signal, which each cell has conventionally had. The table size of the dependency cancellation matrix table is determined by O(n^2) for its configuration, and the increase in the number of entries of the scheduler largely affects the circuit volume. The present embodiment can reduce the circuit volume of a storage devices such as a FF or a latch including a peripheral circuit by half.

The grant signal is configured to keep its value 1 until the corresponding instruction is cancelled if once being set to 1 and always keep notifying a state of issuance to the consumer. Accordingly, the grant signal is referred to as a level scheme for its operation.

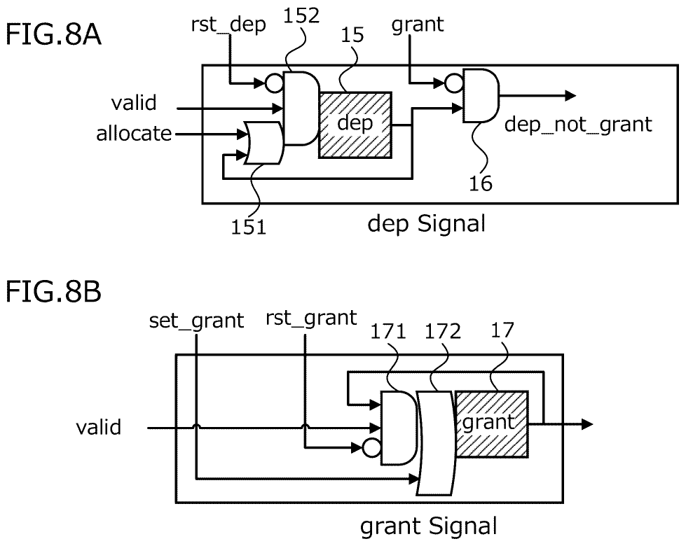

FIG. 8A is a circuit diagram illustrating the dep signal of the embodiment and FIG. 8B is a circuit diagram illustrating the grant signal of the embodiment.

A dep signal 15 illustrated in FIG. 8A and a circuit (i.e., an OR gate 151 and an AND gate 152) that sets the dep signal 15 are the same as those of FIG. 5.

An output of the dep signal 15 is subjected to calculation of a logical conjunction (AND) with the grant signal in an AND gate 16 and then output as illustrated in FIG. 7.

The dep signal 15 is held in a decoding format in which each entry is held in the same number of bits as the number of entries of the scheduler and if the corresponding instruction is depended from multiple instructions, multiple bits can be set to 1 in a single row.

In FIG. 8B, a set_grant signal and a rst_grant signal are the same as the rst_pend signal of FIG. 5 and the set_grand signal in FIG. 6, respectively, of which set and rest are however inverted. In other words, when a producer is issued, set_grant signal is set to set the grant to 1. When the producer is canceled and returned to the scheduler, the rst_grant signal is set to reset the grant to 0. For the above, although there is a difference in set/rst, the rst_grant signal behaves the same as the pend signal 96 of FIG. 5.

FIG. 5 implements a logical conjunction (AND) of a dep signal 95 and pend, but FIG. 8B implements a logical conjunction of the valid in an AND gate 171. This valid is a valid of a scheduler entry of the producer and a signal expected to behave like the rst_dep of FIG. 5 (which means that the valid sets the grant to 0 if the producer is released).

An output from the AND gate 171 and the set_grant signal are input into an OR gate 172, and the output from the OR gate 172 comes to be the grant signal 17.

The grant signal 17 has the function of setting or resetting a signal according to the state of issuance or cancellation of a corresponding scheduler entry.

As comparing of FIG. 5 with FIG. 8B, the circuit behavior and expected behavior are the same, but replacement of the pend signal 96 with the grant signal 17 reduces the circuits as many as the number of entries of the scheduler to a single circuit common in the column direction.

In particular, it is commonly known that a FF (or a storing device such as a latch) has more transistors than a logical gate such as an AND or an OR gate, and these transistors can be replaced with a single AND gate on the matrix table 11, so that the circuit volume can be expected to be largely reduced.

The processor core of the present embodiment has the same configuration as the processor core 1 of FIG. 1.

Instructions that instruct operations of the processor core 1 are stored in the instruction cache 61. Instruction codes read from the instruction cache 61 are stored in the instruction buffer 62 and sequentially sent to the instruction decoder 63.

The instruction decoder 63 carries out instruction interpretation and stores information such as an instruction code into a scheduler.

The scheduler accumulates instructions and speculatively issues the instructions to an arithmetic operator or a cache memory in order of coming to be ready.

In FIG. 1, a scheduler-E 64b that stores arithmetic operation instructions and a scheduler-A 64a that stores memory access instructions such as loading and storing instructions are provided. The scheduler-E 64b, which stores arithmetic operation instructions, has an output connected to the physical GPR 71 and the fixed point arithmetic operator 72 of the arithmetic operation executing unit 7.

The scheduler-A 64a, which accumulates memory access instructions, has an output connected to the physical GPR 71 and the address generating arithmetic operator 73 of the arithmetic operation executing unit 7 and further connected to the loading and storing unit 8 beyond the address generating arithmetic operator 73.

A memory access instruction output from the scheduler-A 64a refers to the physical GPR 71 to calculate the access address to calculate the access address, and the address generating arithmetic operator 73 carries out a process such as an addition using read data. The address obtained in the above manner is then sent to the loading and storing unit 8 and accumulated in a queue called the LDSTQ 81, and are used to access a data cache 82 sequentially.

If the instruction is a loading instruction, data is output from the cache. If the instruction is a fixed-point loading, the data of the instruction is written into the physical GPR 71.

An arithmetic operation instruction output from scheduler-E 64b refers to the physical GPR 71, executes a fixed point arithmetic operation using read data, and writes the result into the physical GPR 71.

Although being omitted in FIG. 1, the scheduler-E 64b can also accumulate floating point arithmetic instructions, and in this event, a floating point arithmetic instructions issued from the scheduler-E 64b executes a floating-point arithmetic operation by referring to the physical GPR 71 in the arithmetic operation executing unit 7.

A scheduler having a function of controlling the order of issuing instructions having dependency and carrying out coordination control for issuing issuable instructions in an out-of-order manner.

The arithmetic operation executing unit 7 has the matrix table 11 containing an at most N×M cells (where N and M are independently of each other natural numbers more than one) and 1×M cells storing the grant signal. The arithmetic operation executing unit 7 stores the dep signal 15, which indicates each cell of the matrix table 11 has dependency with a producer of an entry of the cell. When an instruction is issued from a scheduler, the arithmetic operation executing unit 7 sets a bit of the grant signal 17 corresponding to an issued scheduler entry to 1, and when products of the dep signals 15 of cells in the row direction of the matrix table 11 and an inverted signal of the grant signal are all zero, the arithmetic operation executing unit 7 executes the instruction.

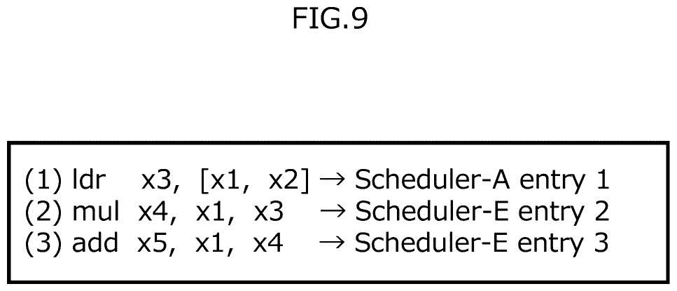

FIG. 9 is a diagram illustrating an example of an instruction string of the embodiment.

For example, in the instruction string of FIG. 9, the instruction (1)ldr calculates an access address to a memory by referring to x1 and x2 of the fixed point register and updates x3 with data read from L1 cache using the result of the calculation.

The instruction of (2)mul multiplies x1 and x3 and updates x4. Since x3 uses the result updated by the instruction (1)ldr, the instruction (2)mul has dependency of respect to the instruction (1) ldr.

The instruction (3)add adds x1 and x4 and updates x5. Since x4 that the instruction (3)add uses the result of the instruction (2)mul, and the instruction (2)mul have dependency with respect to the instruction (3)add.

A scheduler can issue instructions out of the original instruction order. However, if these instructions have dependency as the above, the issuing of the instruction (2)mul needs to wait until the execution of the instruction (1)ldr and the issuing of the instruction (3)add needs to wait until the execution of the instructions of (2)mul.

Among such instructions having dependency, the (1)ldr in relation to the (2)mul and the mul(2) in relation to the (3)add are called producers, and the (2)mul in relation to (1)ldr and the (3)add in relation to(2) mul are called consumers.

The scheduler manages the relationship between the producers and the consumers with a dependency matrix table. There are two schedulers of the scheduler-A 64a and the scheduler-E 64b, each of which can be a producer or a consumer in relation to one another.

### (A-3) First Modification

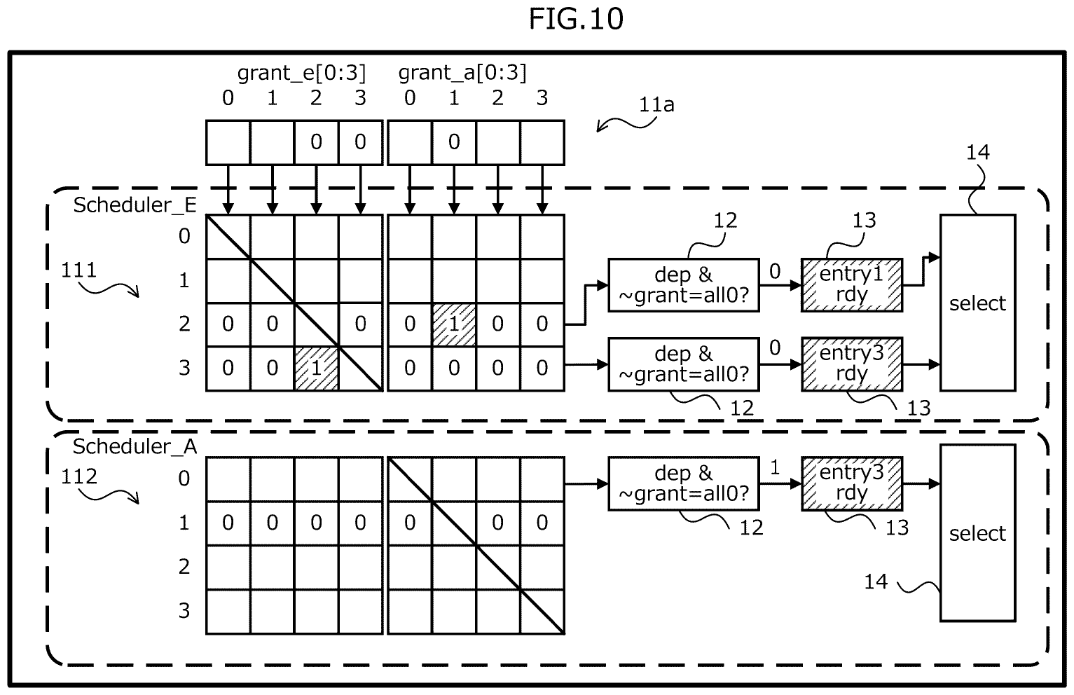

FIG. 10 is a diagram illustrating a first state of the dependency matrix table of a first modification.

The first modification is described assuming that each scheduler consists of four entries.

In this example, if the instruction (1)ldr is stored in the entry 1 of the scheduler-A 64a and the instruction (2)mul and the instruction (3)add are respectively stored in the entry 2 and the entry 3 in the scheduler-B 64b in executing the instruction string of FIG. 9, the dependency matrix table comes into a state illustrated in FIG. 10.

Since each of scheduler-E 64b and the scheduler-A 64a can be either a producer or a consumer, the matrix table 11a is formed into an 8×8 matrix. In the matrix table 11a, the row direction represents a consumer and the column direction represents a producer.

Each consumer holds a 7-bit vector of the scheduler-E 64b and the scheduler-A 64a in the row direction, excluding the bit of itself. These bit vectors are also called dep signals, and each bit in the bit vector indicates the position of the scheduler entry of the producer that the consumer corresponding to the bit has dependency.

In FIG. 10, the left four bits correspond to the scheduler-E 64b and the right four bits correspond to the scheduler-A 64a. For example, since the instruction (2)mul depends on the instruction (1)ldr registered in the entry 1 of the scheduler-A 64a, the corresponding bit is set to 1. Similarly, for the instruction (3)add, the bit corresponding to the entry 2 of the scheduler-B 64b in which entry registers therein the instruction (2)mul is set to 1.

On the top of FIG. 10, grant_e[0:3] and grant_a[0:3] indicate the states of execution of the instructions of the corresponding entries in the scheduler-E 64b and the scheduler-A 64a, respectively. When the bit in this part becomes 1, the bit notifies to the subsequent consumer that the dependency has been resolved because the instruction of the corresponding entry has issued from the scheduler and an arithmetic operation or loading of the instruction has been executed. For example, when the instruction (1)ldr is issued, 1 is set in grant_a [1].

The circuit configuration of each cell of the matrix table 11a of FIG. 10 is the same as that of FIG. 8A.

A dep signal 15 is formed of a storage device such as a FF and a latch, and is configured to hold a value set by a corresponding allocate signal when an instruction is registered in the scheduler.

The dep signal is released from the scheduler when the corresponding producer is issued form the scheduler and the arithmetic operation or the loading process of the producer is completed. At that time, the producer instructs all the consumers to rst (reset) the dep signal. The instruction is accomplished by a res_dep signal, which resets and drops the dep signal 15 to 0.

In the AND gate 152, which sets the dep signal 15, the logical conjunction (AND) of the valid of a scheduler entry of the consumer is calculated. This configuration aims at making dep_val to zero by taking a logical conjunction of the valid in preparation of a case the valid of the scheduler is zero because the rst_dep does not reach due to a branch prediction miss or cancellation due to an asynchronous interruption.

The dep signal 15 is subjected to arithmetic operation of calculating a logical conjunction (AND) with a ˜grant signal in the AND gate 16 (see the reference sign 12 of FIG. 10) and outputted as a dep_not_grant. That is, the dep_not_grant is signal that indicates that the corresponding producer has dependency, but a grant has already reach and therefore the dependency has been resolved, or indicates the corresponding producer does not have dependency in the first place.

A consumer checks all the dep_not_grant signals in the row direction of the dependency table, determines, when all the signals are set to 0, that an instruction can be issued, and sets 1 in a rdy signal represented by the reference sign 13 of FIG. 10.

For example, since all the dep signals 15 in the row direction of the instruction (1)ldr are 0 in FIG. 10, the dep_not_grant are naturally all 0 and rdy=1 is set. Since some dep signals 15 for the instructions (2) and (3) are set to 1 and the corresponding grant signals are 0, the presence of dep_not_grant=1 makes rdy=0, which means that an instruction is not allowed to be issued.

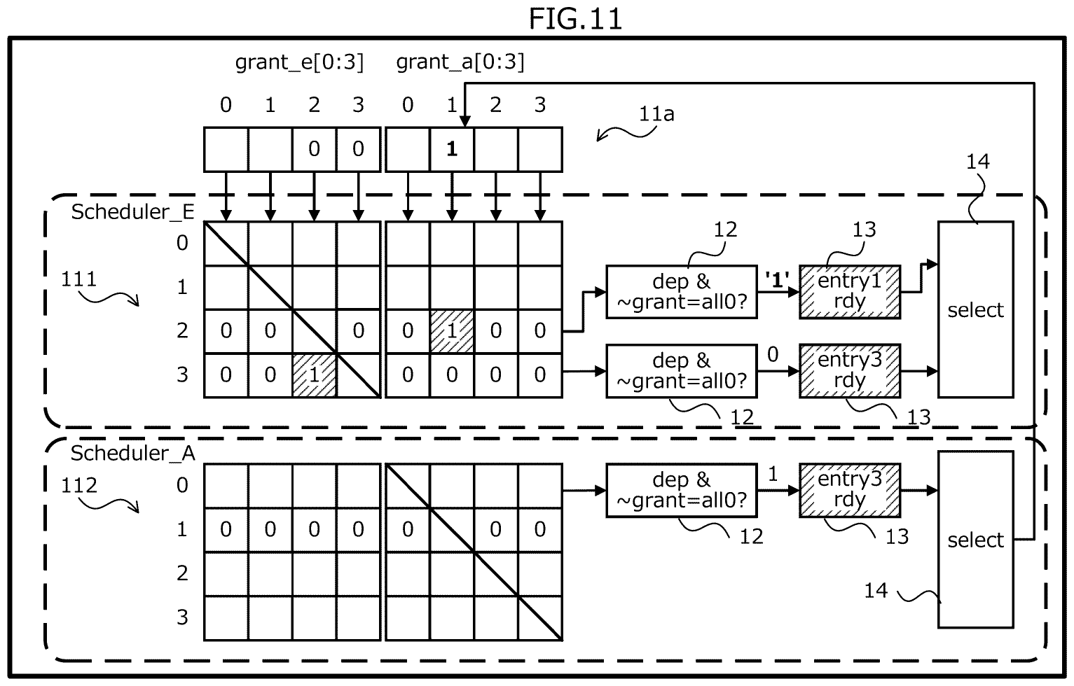

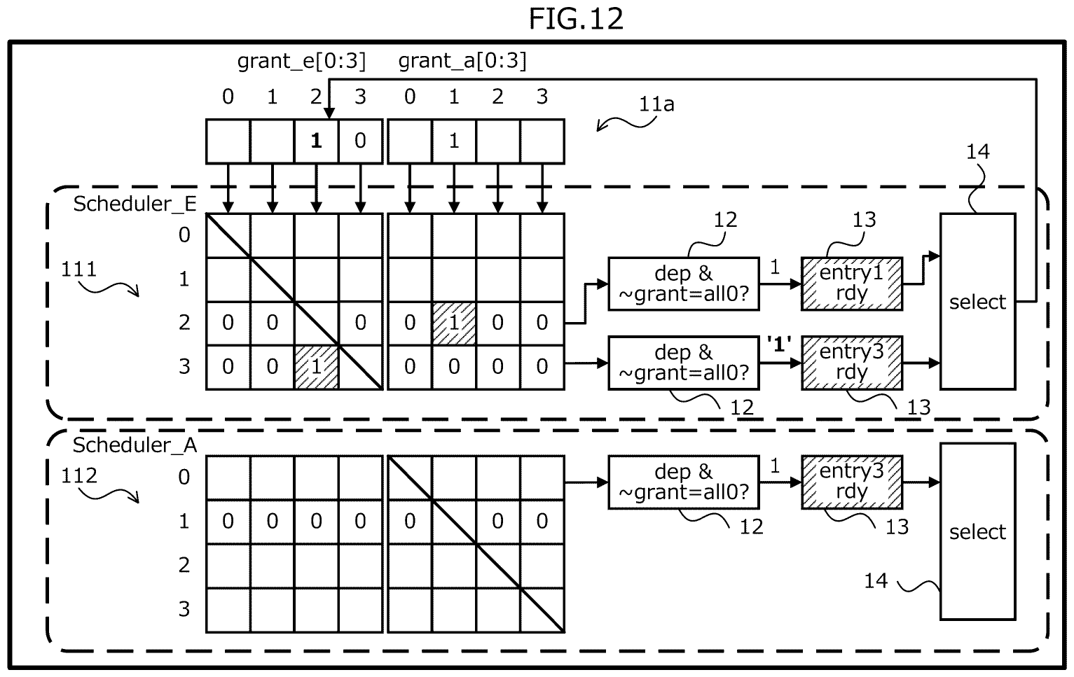

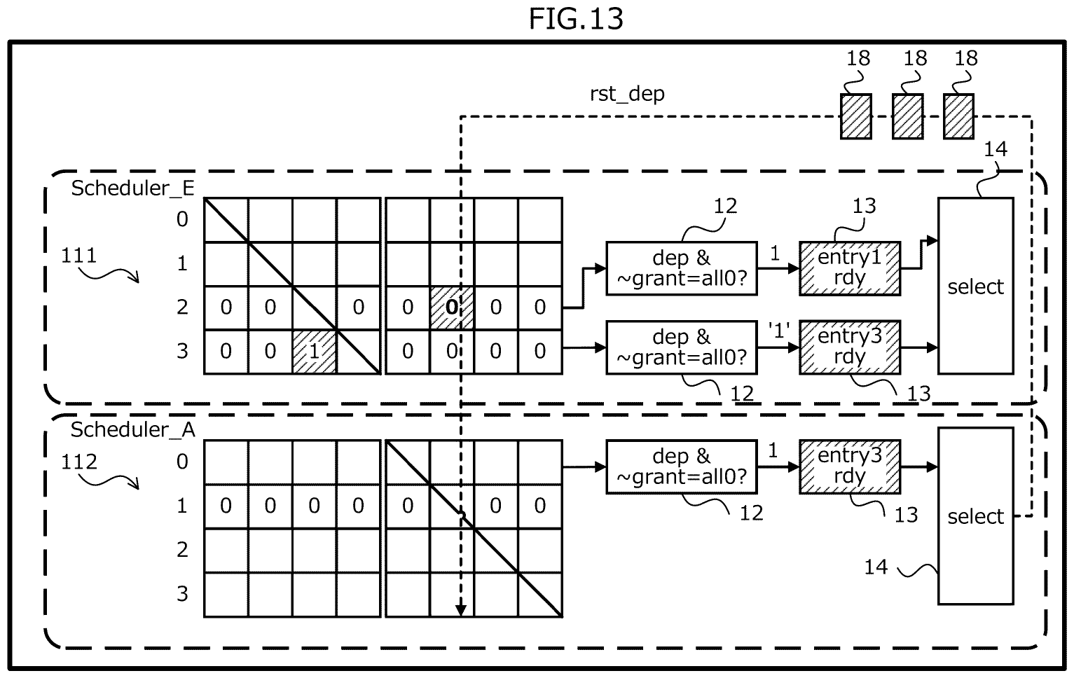

FIG. 11 is a diagram illustrating a second state of the dependency matrix table of the first modification. FIG. 12 is a diagram illustrating a third state of the dependency matrix table of the first modification. FIG. 13 is a diagram illustrating a fourth state of the dependency matrix table of the first modification.

When the instruction (1)ldr is issued as illustrated in FIG. 11, the corresponding grant_a[1] is set to 1. Therefore, since all the dep_not_grant of the entry 2 of the scheduler-E related to the instruction (2)mul is all zero, which results in rdy=1.

Next, as illustrated in FIG. 12, when (2)mul is issued, grant_e[2] is set to 1, which results in rdy=1 and means all the instruction can be issued.

As illustrated in FIG. 13, the instruction (1)ldr is unregistered from scheduler-A 64a when the loading process is completed after appropriate multiple cycles 18 from the issuance of the instruction (1)load. At that time, the valid of of the entry 1 of the scheduler-A is reset (omitted in FIG. 13.). On the other hand, a rst_dep is notified to all the dep signals 15 of the column of the dependency table, and thereby a cell set to 1 is dropped to 0.

The dep signal 15 is reset when an instruction that the corresponding instruction depends on is released from the scheduler. The dep signal 15 is reset when the corresponding scheduler entry is released from the scheduler.

### (A-4) Second Modification

In the matrix table 11a described with reference to FIGS. 10-13, each consumer holds the same number of bits as the number of the corresponding producers with the storing device such as a FF. In the second modification, the bits are held in the encoded form. Here, the first modification and the second modification may be referred to as a decoding scheme and an encoding scheme, respectively.

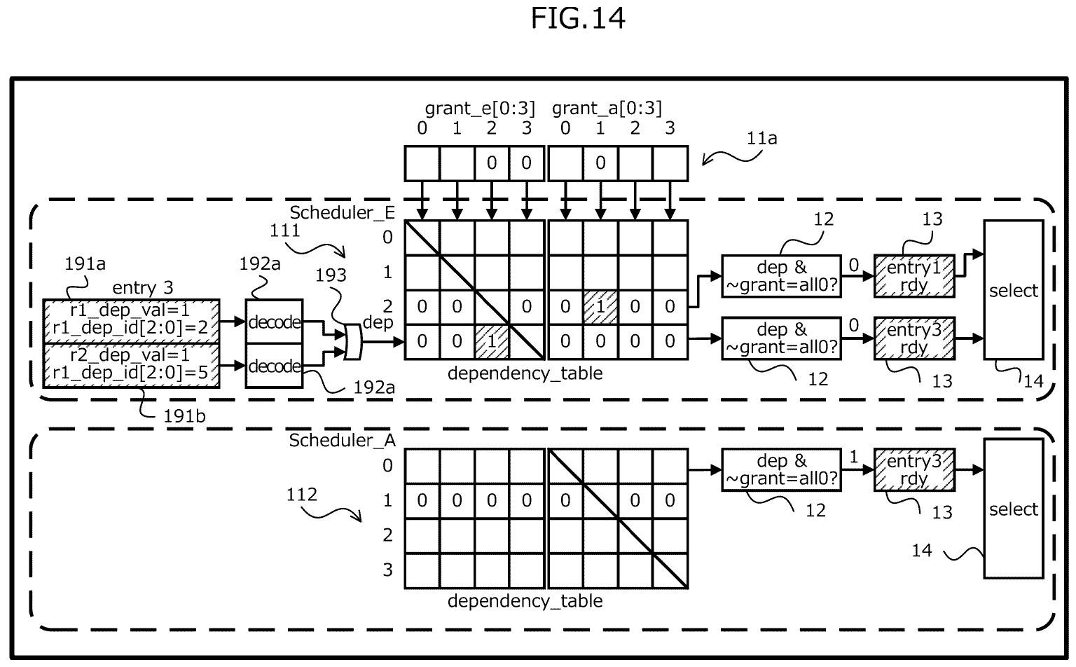

FIG. 14 is a diagram illustrating a dependency matrix table of the second modification.

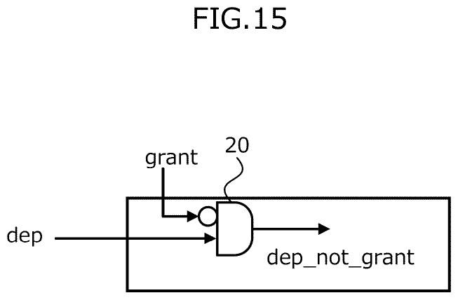

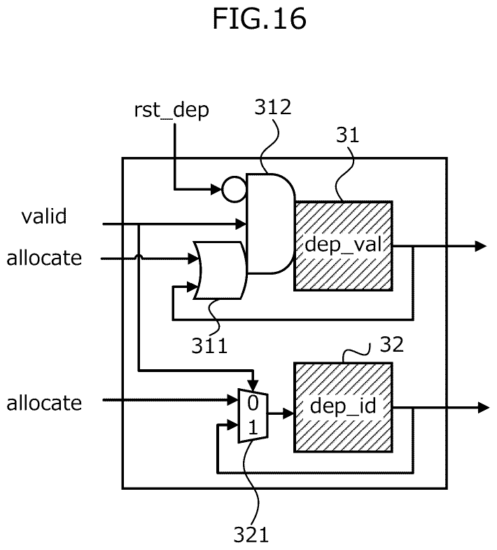

The decoding scheme described in the first modification forms the matrix table 11a of a storing device such as a FF, which is replaced with combination circuits (the inner circuits of the cell is described below with reference to FIG. 15 and FIG. 16) in the second modification illustrated in FIG. 14.

For the above, each consumer holds dep_val and dep_id[2:0] in place of the dep signal (see the reference signs 191a, 191b). Since the same number of dep_val and the same number of dep_id as the number of operands are provided, an instruction that carries out an arithmetic operation on two pieces of data, for example, has two dep-val and two dep_id.

Decoding the dep_val and the dep_id (see the reference signs 192a, 192b) and carrying out a logical disjunction (OR) of all the operands with an OR gate 193 obtains a dep signal the same as one in the decoding scheme. The dep signal 15 is reset when an instruction that the corresponding

instruction depends on is released from the scheduler. The dep signal 15 is reset when the corresponding scheduler entry is released from the scheduler.

FIG. 15 is a circuit diagram of each cell in the encoding scheme in the second modification.

In the circuit diagram of FIG. 15, the logical conjunction (AND) of an inverted signal of the grant and the dep signal is calculated in an AND gate 20 and is outputted as a dep_not_grant. Since a FF and a peripheral circuit are absent in the encoding scheme, the encoding scheme more simplifies the circuit as compared with the decoding scheme.

FIG. 16 is a circuit diagram illustrating a dep_val signal and a dep_id signal according to the second modification.

The dep_val 31 is set to 1 if a producer exists somewhere in the scheduler, and the dep_id 32 registers therein the entry number of the producer in an encoded format.

The dep_val 31 and the dep_id 32 are set when the consumer is registered (allocated) in a reservation station. The logical disjunction (OR) of the allocate and the dep_val31 is calculated in an OR gate 311.

When the consumer is released, the valid of the scheduler is subjected to calculation in an AND gate 312 in order to make the dep_val 31 zero. In the AND gate 312, the logical conjunction of the inverted signal of the rst_dep, the valid, and the output of the OR gate 311 is calculated and output.

The dep_id 32 has a selector 321 at the input to keep the value set therein while the valid is 1.

Similarly to the dep signal of the decoding scheme, the dep_val 31 is configured to be reset when the producer is released (rst_dep). Although being omitted in FIG. 16, the rst_dep can be generated by comparing the dep_id 32 with the id of the producer.

In the above manner, the dependency matrix table of the level scheme can have the dependency information in an encoded format. Since the scheme that can configure the circuit having less circuit volume between the encoding scheme and the decoding scheme depends on the number of operands and the number of entries, the scheme can be se selected according to a manner to be executed.

### (B) Effect

The matrix scheduler and the method of matrix scheduling that concentrate dependency information in a column according to the above embodiment can obtain the following effects and advantages, for example.

The arithmetic operation executing unit 7 has the matrix table 11 containing an at most N×M cells (where N and M are independently of each other natural numbers more than one) and 1×M cells storing the grant signal. The arithmetic operation executing unit 7 stores the dep signal 15, which indicates each cell of the matrix table 11 has dependency with a producer of an entry of the cell. When an instruction is issued from a scheduler, the arithmetic operation executing unit 7 sets a bit of the grant signal 17 corresponding to an issued scheduler entry to 1, and when products of the dep signals 15 of cells in the row direction of the matrix table 11 and an inverted signal of the grant signal are all 0, the arithmetic operation executing unit 7 executes the instruction.

This minimizes an increase of the circuits and an increase of the circuit delay when the number of entries of the scheduler is increased. In addition, this eliminates the requirement of storing the pend signal, which every conventional cell has held, so that the storage capacity of the storing device can be halved.

Specifically, in the pulse scheme of the related example, a table that manages the state of issuance of the producer is referred to immediately before the consumer is registered in the scheduler. In contrast to the above, in the level scheme of the present embodiment, since the state of issuance of the producer is always notified in the grant signal even if the consumer is registered to the scheduler later, a conventional table for managing the state of issuance is no longer necessary and largely reduction in circuit volume and simplification of control can be expected.

Furthermore, the present embodiment can be widely applied regardless the configurations of the scheduler and the dependency matrix table.

The grant signal 17 has the function of setting or resetting a signal according to the state of issuance or cancellation of a corresponding scheduler entry. A grant signal 17 is notified to all the entries of the scheduler.

This properly controls the grant signal 17.

The dep signal 15 is held in a decoding format in which each entry is held in the same number of bits as the number of entries of the scheduler and if the corresponding instruction is depended from multiple instructions, multiple bits can be set to 1 in a single row. The dep signal 15 is reset when an instruction that the corresponding instruction depends on is released from the scheduler. The dep signal 15 is reset when the corresponding scheduler entry is released from the scheduler.

This properly controls the dep signal 15.

The dep signal 15 adopts the encoding scheme in which each entry holds the number of the scheduler that the corresponding instruction depends on which number is encoded for each operand of the instruction. Each entry holds the dep signal 15 in the encoding scheme in which the number of the scheduler which the corresponding instruction depends on for each operand of the instruction is encoded.

This further simplifies the circuit configuration in each cell as compared to that of the decoding scheme.

### (C) Miscellaneous

The disclosed techniques are not limited to the embodiment described above, and may be variously modified without departing from the scope of the present embodiment. The respective configurations and processes of the present embodiment can be selected, omitted, and combined according to the requirement.

As one aspect, it is possible to minimize the increase of the circuits and the circuit delay when the number of entries of the scheduler is increased.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A matrix scheduler that concentrates dependency information in a column comprising:
a memory; and
a processor being coupled to the memory and including a matrix table containing an at most N×M cells and 1×M cells, where N and M are independently of each other natural numbers more than one, the 1×M cells storing a grant signal,
the processor being configured to
store a dep signal into each of the N×M cells, the dep signal indicating the cell has dependency of a producer of an entry of the cell,
when an instruction is issued from the matrix scheduler, set a bit of the grant signal corresponding to an issued scheduler entry to 1, and
when products of the dep signals of cells in one row of the matrix table and an inverted signal of the grant signal are all zero, execute the instruction.

2. The matrix scheduler according to claim 1, wherein the grant signal has a function of setting and resetting the grant signal in accordance with a state of issuance and cancellation of the scheduler entry.

3. The matrix scheduler according to claim 1, wherein the processor is further configured to notify all entries of the scheduler of the grant signal.

4. The matrix scheduler according to claim 1, wherein
the dep signal is held in a decoding format in which each entry is held in the same number of bits as the number of entries of the scheduler and, when an instruction corresponding to the dep signal is depended from multiple instructions, multiple bits are settable to 1 in a single row.

5. The matrix scheduler according to claim 1, wherein the dep signal is held in an encoding scheme in which each entry encodes a number of a scheduler that the entry depends on for each operand of the instruction.

6. The matrix scheduler according to claim 1, wherein the dep signal is reset after an instruction that an entry corresponding to the dep signal depends on is released from the scheduler.

7. The matrix scheduler according to claim 1, wherein the dep signal is reset after the scheduler entry is released from the scheduler.

8. A computer-implemented method for matrix scheduling that concentrates dependency information in a column comprising:
including a matrix table containing an at most N×M cells and 1×M cells, where N and M are independently of each other natural numbers more than one, the 1×M cells storing a grant signal,
storing store a dep signal into each of the N×M cells, the dep signal indicating the cell has dependency of a producer of an entry of the cell,
when an instruction is issued from a scheduler, setting a bit of the grant signal corresponding to an issued scheduler entry to 1, and
when products of the dep signals of cells in one row of the matrix table and an inverted signal of the grant signal are all zero, executing the instruction.

9. The method according to claim 8, wherein
the grant signal has a function of setting and resetting the grant signal in accordance with a state of issuance and cancellation of the scheduler entry.

10. The method according to claim 8, further comprising
notifying all entries of the scheduler of the grant signal.

11. The method according to claim 8, wherein
the dep signal is held in a decoding format in which each entry is held in the same number of bits as the number of entries of the scheduler and, when an instruction corresponding to the dep signal is depended from multiple instructions, multiple bits are settable to 1 in a single row.

12. The method according to claim 8, wherein
the dep signal is held in an encoding scheme in which each entry encodes a number of a scheduler that the entry depends on for each operand of the instruction.

13. The method according to claim 8, wherein
the dep signal is reset after an instruction that an entry corresponding to the dep signal depends on is released from the scheduler.

14. The method according to claim 8, wherein
the dep signal is reset after the scheduler entry is released from the scheduler.
